(19) United States
(12) Patent Application Publication
(10) Pub. No.: US 2020/0013016 A1
(43) Pub. Date: Jan. 9, 2020

(54) INFORMATION PROCESSING APPARATUS AND NON-TRANSITORY COMPUTER READABLE MEDIUM STORING INFORMATION PROCESSING PROGRAM

(71) Applicant: FUJI XEROX CO., LTD., Tokyo (JP)

(72) Inventor: Naoki HAYASHI, Kanagawa (JP)

(73) Assignee: FUJI XEROX CO., LTD., Tokyo (JP)

(21) Appl. No.: 16/455,766

(22) Filed: Jun. 28, 2019

(30) Foreign Application Priority Data
Jul. 5, 2018 (JP) 2018-127972

(51) Int. Cl. G06Q 10/10; H04L 29/08; G06Q 50/00

(52) U.S. Cl. CPC G06Q 10/103; G06Q 50/01; H04L 67/22

(57) ABSTRACT

An information processing apparatus includes a detecting section that detects a difference in degrees of involvement in communication in a community in which plural users participate or a product in the community, between users in the community, and a notification section that notifies, in a case where a predetermined event occurs in the future, based on the difference detected by the detecting section, a first user related to the event or a second user having the difference from the first user of an action request.

### CROSS-REFERENCE TO RELATED APPLICATIONS

This application is based on and claims priority under 35 USC 119 from Japanese Patent Application No. 2018-127972 filed Jul. 5, 2018.

### BACKGROUND

### (i) Technical Field

The present invention relates to an information processing apparatus and a non-transitory computer readable medium storing an information processing program.

### (ii) Related Art

JP3914082B discloses an information presentation system configured to include a plurality of terminal devices and a server device being connected to a network. The server device includes a transmitting and receiving section which transmits and receives message information between the plurality of terminal devices via the network and a first storage section which stores the message information received by the transmitting and receiving section. The terminal device which is a transmitting/receiving source of the message information transmitted or received by the transmitting and receiving section includes a second storage section which stores (a) a type indicating an executed operation among a plurality of operations including “creating” of the message information, “viewing” of an existing message information, and “replying”, “transfer”, and “delete” for the existing message information, (b) an ID of the existing message information of a target to be operated in a case where the types of the operations are “viewing”, “replying”, “transfer”, and “delete”, (c) an ID of the message information generated in a case where the types of the operations are “creating”, “replying”, and “transfer”, (d) a day and time of the operation, and (e) an operation history including a user ID of the terminal device, a relation calculating section which calculates the degree of relation indicating a strength of a relationship between the message information and another message information for each piece of the message information based on dependence of the generated message information obtained from the operation history on the existing message information according to the type of the operation and similarity in contents between the generated message information and the existing message information, a searching section which searches the message information stored in the first storage section based on a searching condition included in a searching request in a case of receiving the searching request from the terminal device, a section which obtains a message group including the message information as a searched result by the searching section and the message information having relation with the message information as the searched result equal to or more than a predetermined threshold value, and a first presentation section which presents information indicating the message group and temporal transition of the number of pieces of the message information in the message group.

JP4425846B discloses a weblog community tracing apparatus which traces weblog communities formed by a plurality of users performing communication on a network. The weblog community tracing apparatus includes a contributing member information extracting section which stores, for each of the weblog communities extracted at a certain timing T1, by setting one or more weblogs which receives comments and trackbacks above a certain standard as contributing members, the comment and the degree of contribution obtained from the number of times of the trackbacks together for each of the contributing members in a database and a tracing section which searches, at a timing T2 when a certain period elapses after the T1, the weblog community having a maximum total value or a total value equal to or larger than a predetermined value of the degrees of contribution of the contributing member stored in the database from the weblog communities including the weblog of the contributing member extracted by the contributing member information extracting section.

JP5296146B discloses a document data management apparatus which provides a community screen for posting document data and viewing the document data for a virtual community to a user terminal of a user who is a member of the virtual community and manages the document data for each of threads which are groups of the document data. The document data management apparatus includes an obtaining section which obtains setting information for generating a second virtual community inheriting the thread included a first existing virtual community, a detecting section which detects a difference between the member of the first virtual community and the member of the second virtual community based on the setting information, a determination section which determines priorities of the threads inherited from the first virtual community to the second virtual community based on the difference, and a first display control section which causes the user terminal to display the community screen of the second virtual community including a thread list in which the threads inherited from the first virtual community are arranged in descending order of priority.

### SUMMARY

In the community in which the plurality of users participate, the communication is performed between the users and a document or the like is created as a product in the community. For example, in the community, an event such as withdrawal or the like of the user occurs. In a case where other members do not take over knowledge from the user before the user withdraws, the knowledge of the user in the community is lost.

Aspects of non-limiting embodiments of the present disclosure relate to an information processing apparatus and a non-transitory computer readable medium storing an information processing program capable of notifying users and the like related to an event of an action request in a case where the event such as withdrawal or the like of a user occurs in the future.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: a detecting section that detects a difference in degrees of involvement in communication in a community in which a plurality of users participate or a product in the community, between users in the community; and a notification section that notifies, in a case where a predetermined event occurs in the future, based on the difference detected by the detecting section, a first user related to the event or a second user having the difference from the first user of an action request.

### BRIEF DESCRIPTION OF THE DRAWINGS

Exemplary embodiment(s) of the present invention will be described in detail based on the following figures, wherein:

FIG. 1 is a conceptual module configuration diagram illustrating a configuration example according to the present exemplary embodiment;

FIG. 2 is an explanatory illustrating a system configuration example using the present exemplary embodiment;

FIG. 3 is an explanatory diagram illustrating a data structure example of a member management table;

FIG. 4 is an explanatory diagram illustrating a data structure example of a thread management table;

FIG. 5 is an explanatory diagram illustrating a data structure example of a product management table;

FIG. 6 is an explanatory diagram illustrating a data structure example of a log management table;

FIG. 7 is a flowchart illustrating a processing example according to the present exemplary embodiment;

FIG. 8 is an explanatory diagram illustrating a data structure example of an involvement difference detection table;

FIG. 9 is an explanatory diagram illustrating a data structure example of a transition instruction template table;

FIGS. 10A and 10B are explanatory diagrams illustrating display examples according to the present exemplary embodiment; and

FIG. 11 is a block diagram illustrating a hardware configuration example of a computer realizing the present exemplary embodiment.

### DETAILED DESCRIPTION

Hereinafter, with reference to the drawings, a description will be made of an exemplary embodiment for realizing the invention.

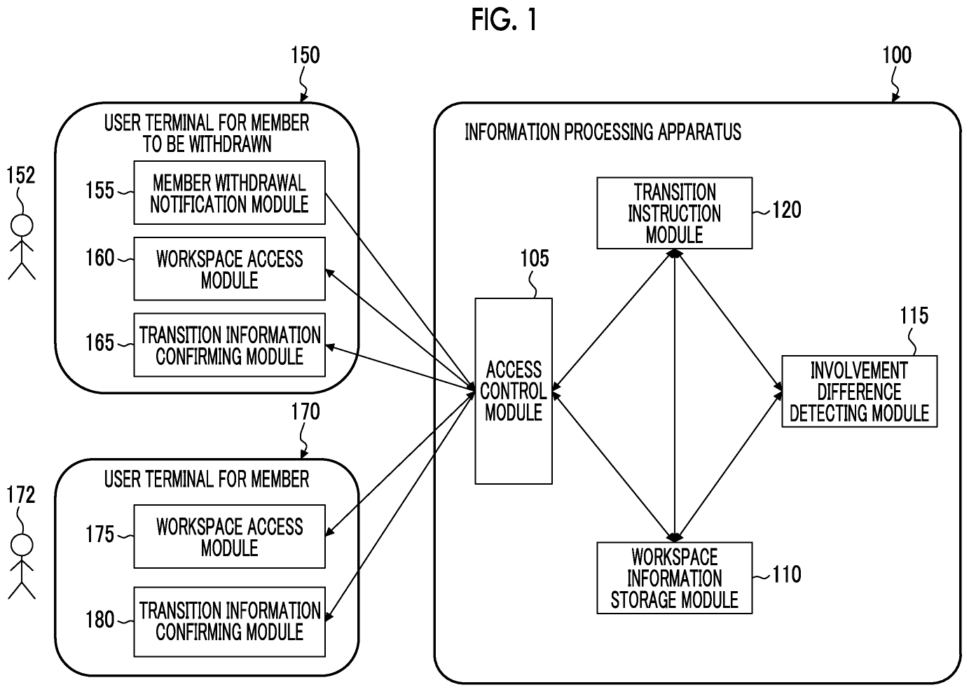

FIG. 1 is a conceptual module configuration diagram illustrating a configuration example according to the present exemplary embodiment.

The module generally indicates components such as software (computer program) or hardware which can be logically divided. Therefore, the module in the present exemplary embodiment indicates not only a module in a computer program but also a module in a hardware configuration. Therefore, in the present exemplary embodiment, a description will also be made of a computer program (a program causing a computer to execute each procedure, a program causing a computer to each of sections, or a program a computer to realize each function), a system, and a method for functioning as such a module. However, for convenience of description, “storing”, “being stored”, or words identical thereto are used, but, these words indicate that a storage device stores data or a storage device is controlled to store data in a case where an exemplary embodiment is a computer program. A module may correspond to a function on a one-to-one basis, and, in installation, a single module may be configured with a single program, a plurality of modules may be configured with a single program, and, conversely, a single module may be configured with a plurality of programs . A plurality of modules may be executed by a single computer, and a single module may be executed by a plurality of computers in a distributed or parallel environment. Other modules may be included in a single module. Hereinafter, the term “connection” indicates only physical connection but also logical connection (transmission and reception of data, instruction, reference relationship between pieces of data, login, and the like). The term “setting in advance” indicates that setting is performed prior to a target process, and indicates not only that setting is performed before a process according to the present exemplary embodiment is started but also that, even after a process according to the present exemplary embodiment is started, setting is performed depending on a situation or a state at the time or a situation or a state hitherto in a case where a target process is not performed. In a case where there are “a plurality of preset values”, the values may be different from each other, and two or more values may be the identical as each other (of course, including all of the values). The description that “in a case of A, B is performed” indicates that “it is determined whether or not A is satisfied, and, in a case where it is determined that A is satisfied, B is performed”. However, this excludes a case where determination of whether or not A is satisfied is unnecessary. In a case where objects are listed such as “A, B, and C”, the objects are exemplarily listed unless otherwise mentioned, and a case where only one thereof (for example, only A) is selected is included.

A system or an apparatus also includes not only a case where a plurality of computers, pieces of hardware, and apparatuses are configured to be connected to each other via a communication means such as a network (including communication connection on a one-to-one basis) but also a case of being realized with a single computer, a single piece of hardware, and a single apparatus. The “apparatus” and the “system” are used as terms having an identical meaning. Of course, the “system” does not include systems that are merely a social “mechanism” (social system) which is an artificial arrangement.

Target information is read from a storage device, the process is performed, and a process result is written to the storage device for each process performed by each module or for each process in a case where a plurality of processes are performed in a module. Therefore, description of reading for a storage device before a process and writing for the storage device after the process will be omitted. The storage device here may include a hard disk, a random access memory (RAM), an external storage medium, a storage device connected via a communication line, a register in a central processing unit (CPU), or the like.

An information processing apparatus 100 according to the present exemplary embodiment is provided for supporting a communication in a virtual community (hereinafter, referred to as “community”) in which a plurality of users (hereinafter, referred to as “members”) participate. As illustrated in FIG. 1, the information processing apparatus 100 includes an access control module 105, a workspace information storage module 110, an involvement difference detecting module 115, and a transition instruction module 120. The information processing apparatus 100 may be configured to include some functions of a collaboration system. In addition, the community is a group including the plurality of users managed by a system such as a collaboration system or the like which supports collaborative work.

The information processing apparatus 100 is connected to a user terminal for member to be withdrawn 150 and a user terminal for member 170. A plurality of the user terminals for member to be withdrawn 150 and a plurality of the user terminals for member 170 may be provided. The user terminal for member to be withdrawn 150 is a terminal used by a member 152 who will withdraw. The user terminal for member 170 is a terminal used by a member 172 other than the member 152 to be withdrawn.

It is not necessary to distinguish between the user terminal for member to be withdrawn 150 and the user terminal for member 170. A workspace access module 160 inside the user terminal for member to be withdrawn 150 may be identical with a workspace access module 175 inside the user terminal for member 170. A transition information confirming module 165 inside the user terminal for member to be withdrawn 150 may be identical with a transition information confirming module 180 inside the user terminal for member 170. The user terminal for member 170 may include a member withdrawal notification module 155. In addition, in a case where it becomes necessary to notify withdrawal or the like, a program corresponding to the member withdrawal notification module 155 may be downloaded in the user terminal for member to be withdrawn 150 by an operation of the member 152.

The user terminal for member to be withdrawn 150 and the user terminal for member 170 can communicate with the information processing apparatus 100. For example, the user terminal for member to be withdrawn 150 and the user terminal for member 170 may be personal computers (including notebook PCs), mobile information communication devices (including mobile phones, smartphones, mobile devices, wearable computers, or the like), and the like.

The members in the community are often flexible. In the technology described in the related art, it is possible to evaluate an involvement and a contribution of the member in the community. However, there is no point of view as a countermeasure in a case where a certain member withdraws from the community. In the case where the member related to details or a background information of a determined subject withdraws from the community, the details or the background information is lost. The withdrawal or the like includes withdrawal and long-term absence. In the following examples, a description will be made by using the withdrawal. In addition to collaboration or the like between companies, the community may include organizations such as company and the like. That is, one community may be formed to include all of the organizations. Therefore, the withdrawal also includes retirement and the like.

In the present exemplary embodiment, for example, the following process is performed. Specifically, the description is provided for facilitating the understanding of the present exemplary embodiment, but it is not intended to limit interpretation using the description. It is naturally determined that an invention to be patented by using only the description part is described in the detailed description of the exemplary embodiment of the invention (under Patent Act Article 36(6) (i)).

In a case where a certain member belonging to the community notifies the information processing apparatus 100 of the planned withdrawal from the community, the information processing apparatus 100 determines how another member is related to the communication (workspace, message thread, or the like) or the product to which the member is related. Based on the determination, the information processing apparatus 100 prompts the member or the other member to perform communication or to generate materials for the transition before the planned withdrawal.

The determination to prompt the transition is performed as the following by comparing the member with the other member.

(1) contribution of the member to the product is large (representative author, large number of pages in charge, in charge of reviewer, or the like)

(2) communication involvement is large (number of posts, number of valid responses to questions, in charge of facilitator, or the like)

The access control module 105 is connected with the workspace information storage module 110, the transition instruction module 120, the member withdrawal notification module 155, the workspace access module 160, and the transition information confirming module 165 of the user terminal for member to be withdrawn 150, and the workspace access module 175 and the transition information confirming module 180 of the user terminal for member 170. The access control module 105 communicates with the user terminal for member to be withdrawn 150 and the user terminal for member 170. In a case of receiving a predetermined notification such as withdrawal or the like, the access control module 105 notifies an action request and the like according to the withdrawal or the like. The notification includes, for example, an E-mail, a chat, an electronic bulletin board, a notification using social media, a push notification, a telephone call by automatic voice response, and the like. For example, Lync (registered trademark) or the like may be used as the telephone call.

Specifically, the access control module 105 has a function of limiting an operation in the workspace according to authentication of the member and permission information given to the member based on the authentication information and the permission information stored in the workspace information storage module 110 in a case where the member accesses to the workspace of the collaboration system (information processing apparatus 100).

In addition, in a case of receiving the notification such as the withdrawal of the member or the like, the access control module 105 transfers information of the member to the transition instruction module 120.

Further, in a case where the transition information is transferred from the transition instruction module 120, the access control module 105 has a function of notifying the member included in the information of the transition information.

The workspace information storage module 110 is connected with the access control module 105, the involvement difference detecting module 115, and the transition instruction module 120. The workspace information storage module 110 stores information and the like related to the information of the member or the communication between the members. The workspace information storage module 110 stores, for example, a member management table 300, a thread management table 400, a product management table 500, a log management table 600, an involvement difference detection table 800, a transition instruction template table 900, and the like described below such as documents which are threads or products.

Specifically, the workspace information storage module 110 has a function of storing information on the workspace in the collaboration system (information processing apparatus 100).

The information on the workspace includes information such as a workspace name, a member of a workspace, a message or a document exchanged in the workspace, authentication information for the member, permission information of the message or the document for a participant of the workspace, and the like.

The involvement difference detecting module 115 is connected with the workspace information storage module 110 and the transition instruction module 120. The involvement difference detecting module 115 detects a difference in the degree of involvement in the communication in the community or the product in the community, between users in the community in which a plurality of users participate. Here, “involvement” includes a contribution. For example, the involvement difference detecting module 115 detects whether or not there is the difference in the degree of involvement in a certain thread or product, between the community members.

Specifically, based on member information transferred from the transition instruction module 120 as a trigger, the involvement difference detecting module 115 detects another member having a difference in involvement from the transferred member for the involvement in the message thread or the document. The involvement difference detecting module 115 has a function of transmitting the transferred member, the other detected member, information on the message thread or the document having the difference in the involvement, and information on a relation type to the transition instruction module 120.

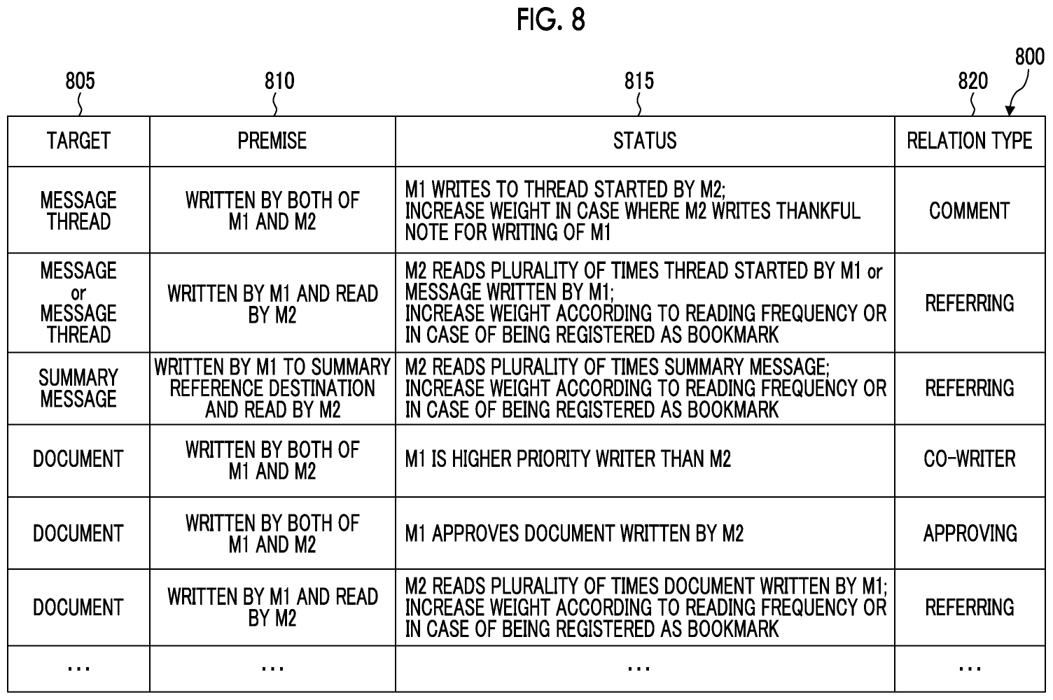

In involvement difference detecting module 115, a case where the involvement of a certain member exceeds the involvement of other members is stored (to be described below by using an example in FIG. 8). By using this case, the difference in the involvement between the members is detected.

The difference may be detected in a case where there is even a small difference, or the difference may be detected in a case where a certain degree of difference occurs by providing weighting or a threshold value (function).

The transition instruction module 120 is connected with the access control module 105, the workspace information storage module 110, and the involvement difference detecting module 115. In a case where a predetermined event occurs in the future, based on the difference detected by the involvement difference detecting module 115, the transition instruction module 120 notifies a first user related to the event or a second user having the difference from the first user of the action request. For example, with a specific event as a trigger, the transition instruction module 120 notifies the action request based on the difference detected by the involvement difference detecting module 115 to the community member having the detected difference.

A timing of performing the notification may be a case where it is detected that the predetermined event occurs in the future (for example, as soon as the event is detected) or may be a timing before a predetermined period of a time when the predetermined event occurs in the future (for example, one week before the event occurrence or the like).

“Predetermined event” includes withdrawal or long-term absence from the community. “First user” includes a withdrawer or a long-term absentee. “Long-term absence” includes, for example, a long vacation or the like. In some cases, the long-term may exceed a predetermined period. In this case, the period as a threshold value may be a value different from the predetermined period according to the community, a schedule (phase in the schedule), and the like. For example, in the schedule, a short period (for example, two days or the like) may be set as a threshold value in a case immediately before a delivery date and a long-term period (for example, 7 days or the like) as the threshold value in a case of planning.

In a case where the specific event is that the member withdraws from the community, the action request is that other members take knowledge over from the member to be withdrawn. That is, it is possible to prevent the knowledge from being lost according to the withdrawal of the member by taking the action before the withdrawal.

In addition, the second user may be a user having a lower degree of involvement than the first user. That is, other members not having the knowledge take the knowledge over from the withdrawer.

In addition, the transition instruction module 120 may not notify the user having a higher degree of involvement than the first user. That is, in a case where other members have the knowledge of the withdrawer, it is not necessary to take the knowledge over from the withdrawer. This reduces a burden on the withdrawer and the user having the high degree of involvement.

Further, the transition instruction module 120 may select a user who communicates with the first user or a user who involves in the product together with the first user, as the second user.

The transition instruction module 120 may further include a condition that the user is a user who performs a predetermined operation on the first user, as a condition of the second user.

In addition, the transition instruction module 120 may not execute the action request for the thread or the product not required to be maintained or taken over. For example, an old material (product as a predetermined period elapses after a creation day and time, a product already published, and the like) are included. That is, the action is not required for those that do not need to prevent the knowledge from being lost.

Specifically, based on the member information transferred from the access control module 105 as a trigger, the transition instruction module 120 has a function of generating transition instruction information to the member and transferring the transition instruction information to the access control module 105.

The transition instruction information includes, for example, the following contents.

an ID and a name of a member to be withdrawn

The next enumeration is a set of information. In some cases, there are a plurality of sets of the members to be withdrawn.

an ID and a name of a related member (in some cases, there are a plurality of members)

an ID and a document name of a related document or an ID and a message name of a related message thread

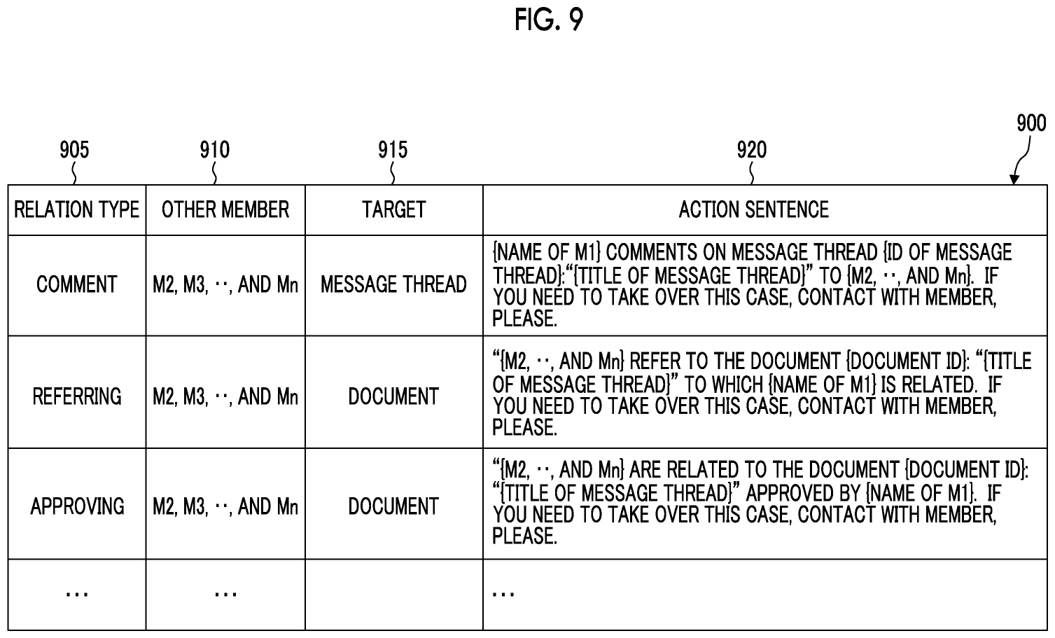

a sentence in which an action request is written (to be described below by using the example in FIG. 9)

The user terminal for member to be withdrawn 150 includes the member withdrawal notification module 155, the workspace access module 160, and the transition information confirming module 165.

The member withdrawal notification module 155 is connected to the access control module 105 of the information processing apparatus 100. The member withdrawal notification module 155 has a function of notifying the collaboration system (information processing apparatus 100) of that the member withdraws from the group of the collaboration system (information processing apparatus 100) according to an operation of the member.

The workspace access module 160 is connected to the access control module 105 of the information processing apparatus 100. The workspace access module 160 has a function of the member accessing to the workspace of the collaboration system (information processing apparatus 100) so as to exchange the message with other members or register, edit, and delete the document.

The transition information confirming module 165 is connected to the access control module 105 of the information processing apparatus 100. The transition information confirming module 165 has a function in which the member confirms the transition information notified from the collaboration system (information processing apparatus 100). The transition information is generated by the transition instruction module 120.

The user terminal for member 170 includes the workspace access module 175 and the transition information confirming module 180.

The workspace access module 175 is connected to the access control module 105 of the information processing apparatus 100. The workspace access module 175 has the identical function as the workspace access module 160 and has the function of the member accessing to the workspace of the collaboration system (information processing apparatus 100) so as to exchange the message with other members or register, edit, and delete the document.

The transition information confirming module 180 is connected to the access control module 105 of the information processing apparatus 100. The transition information confirming module 180 has the identical function as the transition information confirming module 165 and has the function in which the member confirms the transition information notified from the collaboration system (information processing apparatus 100). The transition information is generated by the transition instruction module 120.

An outline of the action request (transition instruction information) is generated as follows.

1. The user terminal for member to be withdrawn 150 notifies the access control module 105 of the withdrawal. The access control module 105 transfers the information of the member to be withdrawn (information in the workspace information storage module 110) to the involvement difference detecting module 115.

2. The involvement difference detecting module 115 extracts a user to take over (a user having a lower degree of involvement than the member to be withdrawn).

3-1. The transition instruction module 120 generates a description of the action request from the “relation type” (a relation type field 820 of the involvement difference detection table 800 illustrated in FIG. 8 or a relation type field 905 of the transition instruction template table 900 illustrated in FIG. 9) in the information returned from the involvement difference detecting module 115.

3-2. The transition instruction module 120 generates the transition instruction information from the information of the member to be withdrawn, the information returned from the involvement difference detecting module 115, and the generated description of the action request.

4. The transition instruction module 120 transfers the transition instruction information to the access control module 105. The access control module 105 transmits the transition instruction information to the user terminal for member to be withdrawn 150 (member 152) and the user terminal for member 170 (member 172) corresponding to the user to take over.

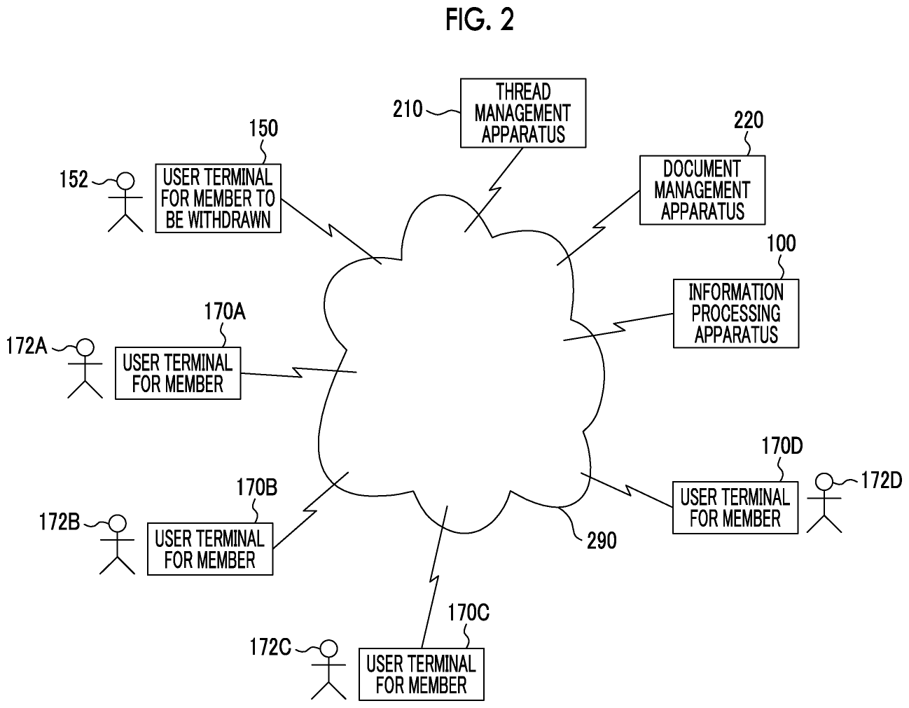

FIG. 2 is an explanatory diagram illustrating a system configuration example using the present exemplary embodiment.

The information processing apparatus 100, the user terminal for member to be withdrawn 150, a user terminal for member 170A, a user terminal for member 170B, a user terminal for member 170C, a user terminal for member 170D, a thread management apparatus 210, and a document management apparatus 220 are connected with one another via a communication line 290. The communication line 290 may be wireless, wired, or a combination thereof and may be, for example, the internet as an infrastructure for communication, an intranet, or the like. In addition, the functions of the information processing apparatus 100, the thread management apparatus 210, and the document management apparatus 220 may be realized as a cloud service.

The community is formed by the member 152, the member 172, and the like, and the information processing apparatus 100 performs a communication process in the community. The document management apparatus 220 manages the document which is a product in the community, and the thread management apparatus 210 manages the communication in the community. The document (also referred to as a file) is text data, numerical data, graphic data, image data, movie data, audio data, or the like or a combination thereof, and is subject to storage, editing, search, or the like, can be exchanged between the systems or the users as individual units, and includes those similar to these. Specifically, the document includes a document created by a document creating program (so-called word processor software), an image read by an image reading apparatus (scanner or the like), a web page, and the like.

Ina case of receiving the notification of the withdrawal from the member 152 (user terminal for member to be withdrawn 150), the information processing apparatus 100 notifies the action request for prompting the transition so that the other member 172 takes the knowledge over from the member 152.

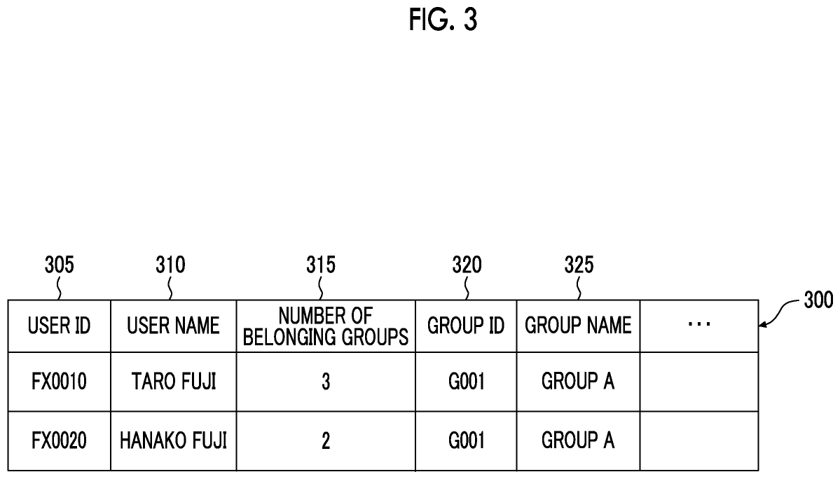

FIG. 3 is an explanatory diagram illustrating a data structure example of the member management table 300. The workspace information storage module 110 stores the member management table 300. The member management table 300 manages the user and the group to which the user belongs.

The member management table 300 includes a user ID field 305, a user name field 310, a number of belonging groups field 315, a group ID field 320, and a group name field 325. In the present exemplary embodiment, the user ID field 305 stores information (user ID: identification) for uniquely identifying the user. The user name field 310 stores a name of the user. The number of belonging groups field 315 stores the number of groups to which the user belongs. After then, sets of the group ID field 320 and the group name field 325, by a number in the number of belonging groups field 315, are followed. In the present exemplary embodiment, the group ID field 320 stores information (group ID) for uniquely identifying the group. The group name field 325 stores a name of the group. In addition to this, information and the like for authenticating the user may be stored.

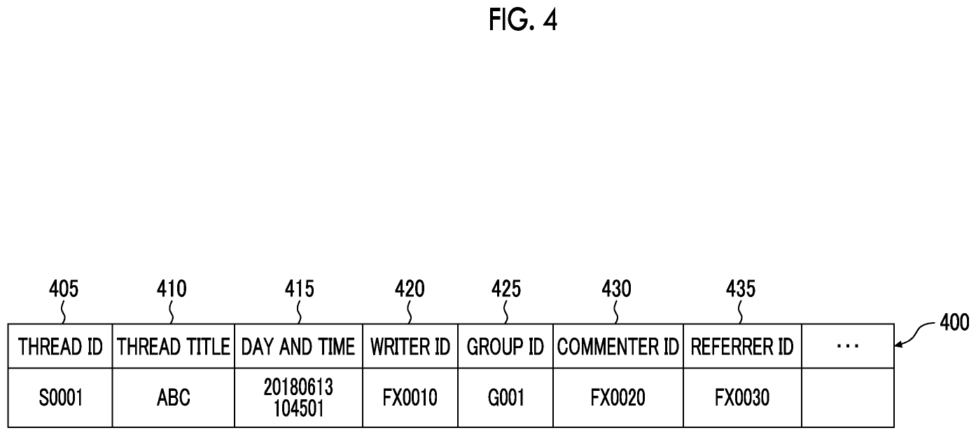

FIG. 4 is an explanatory diagram illustrating a data structure example of the thread management table 400. The workspace information storage module 110 stores the thread management table 400. The thread management table 400 manages information (specifically, thread) of communication performed between the users.

The thread management table 400 includes a thread ID field 405, a thread title field 410, a day and time field 415, a writer ID field 420, a group ID field 425, a commenter ID field 430, and a referrer ID field 435. In the present exemplary embodiment, the thread ID field 405 stores information (thread ID) for uniquely identifying the thread. The thread title field 410 stores a title of the thread. The day and time field 415 stores a day and time (year, month, day, hour, minute, second, second or less, or a combination thereof) on which the thread is generated. The writer ID field 420 stores the user ID of a writer who generates the thread. The group ID field 425 stores the group ID. The commenter ID field 430 stores the user ID of a commenter who comments on the thread. The referrer ID field 435 stores the user ID of a referrer who refers to the thread. The user having a relationship with the withdrawer can be extracted from the writer ID field 420, the commenter ID field 430, and the referrer ID field 435. Specifically, the user ID of the withdrawer may be searched from the writer ID field 420, the commenter ID field 430, and the referrer ID field 435 and the user ID of another user may be extracted from the writer ID field 420, the commenter ID field 430, and the referrer ID field 435 in the thread.

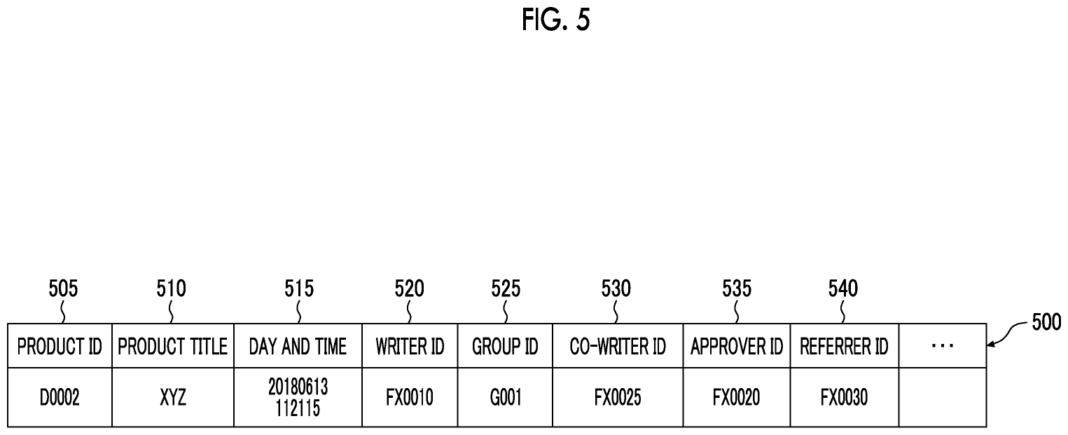

FIG. 5 is an explanatory diagram illustrating a data structure example of the product management table 500. The workspace information storage module 110 stores the product management table 500. The product management table 500 manages a product (specifically, document) of communication performed between the users.

The product management table 500 includes a product ID field 505, a product title field 510, a day and time field 515, a writer ID field 520, a group ID field 525, a co-writer ID field 530, an approver ID field 535, and a referrer ID field 540. In the present exemplary embodiment, the product ID field 505 stores information (product ID) for uniquely identifying the product. The product title field 510 stores a title of the product. The day and time field 515 stores a day and time on which the product is generated. The writer ID field 520 stores the user ID of a writer who generates the product. The group ID field 525 stores the group ID. The co-writer ID field 530 stores the user ID of a co-writer who generates the product. The approver ID field 535 stores the user ID of an approver who approves the product. The referrer ID field 540 stores the user ID of a referrer who refers to the product. The user having a relationship with the withdrawer can be extracted from the writer ID field 520, the co-writer ID field 530, the approver ID field 535, and the referrer ID field 540. Specifically, the user ID of the withdrawer may be searched from the writer ID field 520, the co-writer ID field 530, the approver ID field 535, and the referrer ID field 540 and the user ID of another user may be extracted from the writer ID field 520, the co-writer ID field 530, the approver ID field 535, and the referrer ID field 540 in the product.

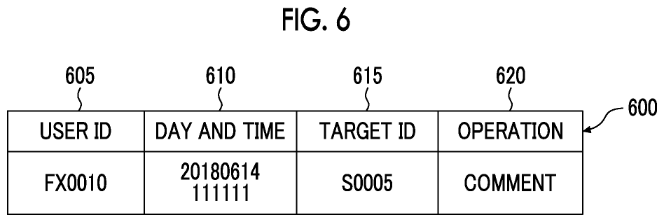

FIG. 6 is an explanatory diagram illustrating a data structure example of the log management table 600. The workspace information storage module 110 stores the log management table 600. The log management table 600 manages an operation (so-called log) performed by the user in the community.

The log management table 600 includes a user ID field 605, a day and time field 610, a target ID field 615, and an operation field 620. The user ID field 605 stores the user ID. The day and time field 610 stores a day and time on which the user performs the operation. The target ID field 615 stores the ID (for example, thread ID or product ID) which is a target. The operation field 620 stores the operation (for example, creating, commenting, approving, referring, or the like on the thread or the product) which the user performs on the target.

The user having a relationship with the withdrawer can be extracted by using the log management table 600. Specifically, the user who performs the operation on the identical thread or product as the thread or product which is an operation target of the withdrawer may be extracted.

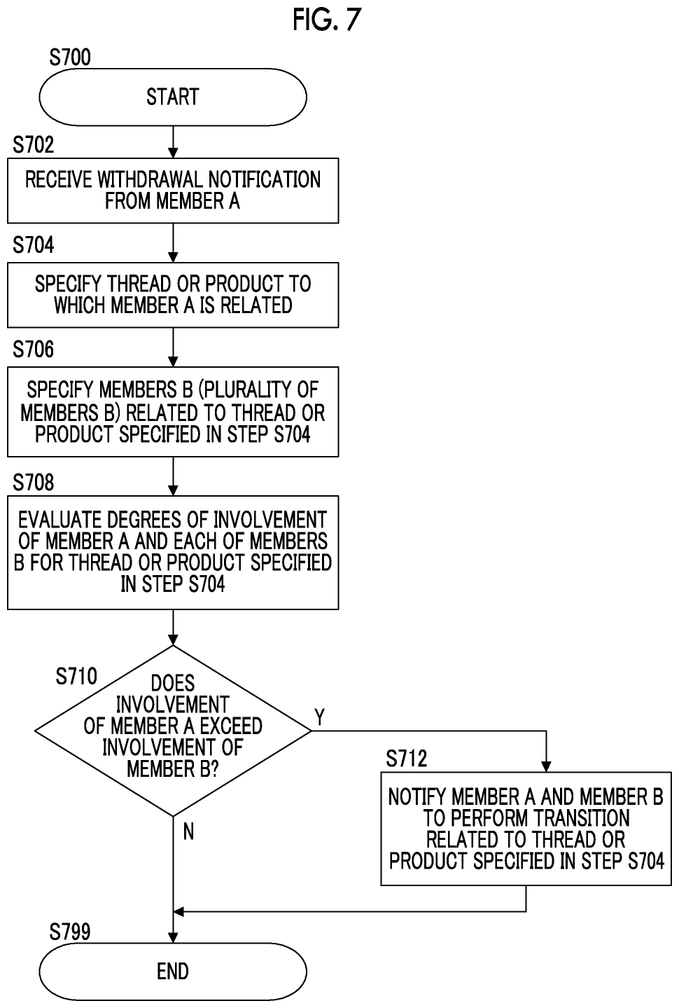

FIG. 7 is a flowchart illustrating a processing example according to the present exemplary embodiment.

Instep S702, the access control module 105 receives the withdrawal notification from a member A.

In step S704, the involvement difference detecting module 115 specifies the thread or the product to which the member A is related. Specifically, by using the thread management table 400 and the product management table 500, the thread or the product to which the member A is related may be extracted.

In step S706, the involvement difference detecting module 115 specifies members B (generally, there are a plurality of members B) related to the thread or the product specified in step S704. Specifically, by using the thread management table 400, the product management table 500, and the log management table 600, the member B related to the thread or the product to which the member A is related may be extracted.

In step S708, the involvement difference detecting module 115 evaluates the degrees of involvement of the member A and each of the members B for the thread or the product specified in step S704. For example, the involvement difference detecting module 115 evaluates the degree of involvement by using the involvement difference detection table 800.

FIG. 8 is an explanatory diagram illustrating a data structure example of the involvement difference detection table 800. The involvement difference detecting module 115 uses the involvement difference detection table 800. The involvement difference detection table 800 illustrates an example of a case where the involvement of a member M1 exceeds the involvement of a member M2.

The involvement difference detection table 800 includes a target field 805, a premise field 810, a status field 815, and the relation type field 820. The target field 805 stores a target (for example, message, message thread, summary message, document, or the like). The premise field 810 stores a premise for applying the status field 815. The status field 815 stores a status. The relation type field 820 stores the relation type. The relation type field 820 illustrates the relation type of the member M1 and the member M2 in a case where the target field 805, the premise field 810, and the status field 815 are satisfied. The relation type field 820 is used in the relation type field 905 of the transition instruction template table 900 illustrated in FIG. 9.

The involvement difference detecting module 115 extracts the member M2 satisfying a condition of the premise field 810 and satisfying a condition of the status field 815 for targets of the target field 805. That is, the involvement difference detection table 800 illustrates an example of a rule of “a user who communicates with the first user or a user who involves in the product together with the first user, as the second user” or “a condition of a user who performs a predetermined operation on the first user”.

A first line of the involvement difference detection table 800 includes “message thread” as a target, “written by both of M1 and M2” as a premise, “M1 writes to a thread started by M2; Increase a weight in a case where M2 writes a thankful note for the writing of M1” as a status, and “comment” as a relation type.

A second line of the involvement difference detection table 800 includes “message or message thread” as a target, “written by M1 and read by M2” as a premise, “M2 reads a plurality of times the thread started by M1 or the message written by M1; Increase a weight according to a reading frequency or in a case of being registered as a bookmark” as a status, and “referring” as a relation type.

A third line of the involvement difference detection table 800 includes “summary message” as a target, “written by M1 to a summary reference destination and read by M2” as a premise, “M2 reads a plurality of times the summary message; Increase a weight according to a reading frequency or in a case of being registered as a bookmark” as a status, and “referring” as a relation type.

A fourth line of the involvement difference detection table 800 includes “document” as a target, “written by both of M1 and M2” as a premise, “M1 is a higher priority writer than M2” as a status, and “co-writer” as a relation type.

A fifth line of the involvement difference detection table 800 includes “document” as a target, “written by both of M1 and M2” as a premise, “M1 approves the document written by M2” as a status, and “approving” as a relation type.

A sixth line of the involvement difference detection table 800 includes “document” as a target, “written by M1 and read by M2” as a premise, “M2 reads a plurality of times the document written by M1; Increase a weight according to a reading frequency or in a case of being registered as a bookmark” as a status, and “referring” as a relation type.

By referring to the thread management table 400, the product management table 500, and the log management table 600, it is possible to determine whether or not the condition of the status field 815 is satisfied.

In step S710, by using a processing result in step S708, the transition instruction module 120 determines whether or not the involvement of the member A exceeds the involvement of the member B. In a case where the involvement of the member A exceeds the involvement of the member B, the process moves to step S712. In other cases, the process is terminated (step S799).

In step S712, the transition instruction module 120 notifies the member A and the member B so as to cause the member A and the member B to perform the transition related to the thread or the product specified in step S704. For example, the sentence for the notification is created by using the transition instruction template table 900.

FIG. 9 is an explanatory diagram illustrating a data structure example of the transition instruction template table 900. The transition instruction module 120 uses the transition instruction template table 900.

The transition instruction template table 900 includes the relation type field 905, an other member field 910, a target field 915, and an action sentence field 920. The relation type field 905 stores the relation type. The other member field 910 stores other members. The target field 915 stores a target. The action sentence field 920 stores the sentence of the action request.

The transition instruction template table 900 stores “relation type” (relation type field 820 of the involvement difference detection table 800 illustrated in FIG. 8) returned from the involvement difference detecting module 115 and a template of the sentence of the action request in association with each other.

Some parts of the sentence of the template in the action sentence field 920 are variables (that is, cloze test) and the name of the user and the document, or the message thread returned from the involvement difference detecting module 115 becomes values of the variables.

In the template of the action sentence field 920, the member M1 is the member to be withdrawn. Then, {x} in the template indicates that the sentence is replaced as a variable.

A first line of the transition instruction template table 900 displays that the relation type is “comment”, the other member is “M2, M3, . . . , and Mn”, and in a case where the target is “message thread”, the sentence of the action request is “{name of M1} comments on the message thread {ID of message thread}: “{title of message thread}” to {M2, . . . , and Mn}. If you need to take over this case, contact with the member, please.”.

A second line of the transition instruction template table 900 displays that the relation type is “referring”, the other member is “M2, M3, . . . , and Mn”, and in a case where the target is “document”, the sentence of the action request is “{M2, . . . , and Mn} refer to the document {document ID}: “{title of message thread}” to which {name of M1} is related. If you need to take over this case, contact with the member, please.”.

A third line of the transition instruction template table 900 displays that the relation type is “approving”, the other member is “M2, M3, . . . , and Mn”, and in a case where the target is “document”, the sentence of the action request is “{M2, . . . , and Mn} are related to the document {document ID}: “{title of message thread}” approved by {name of M1}. If you need to take over this case, contact with the member, please.”.

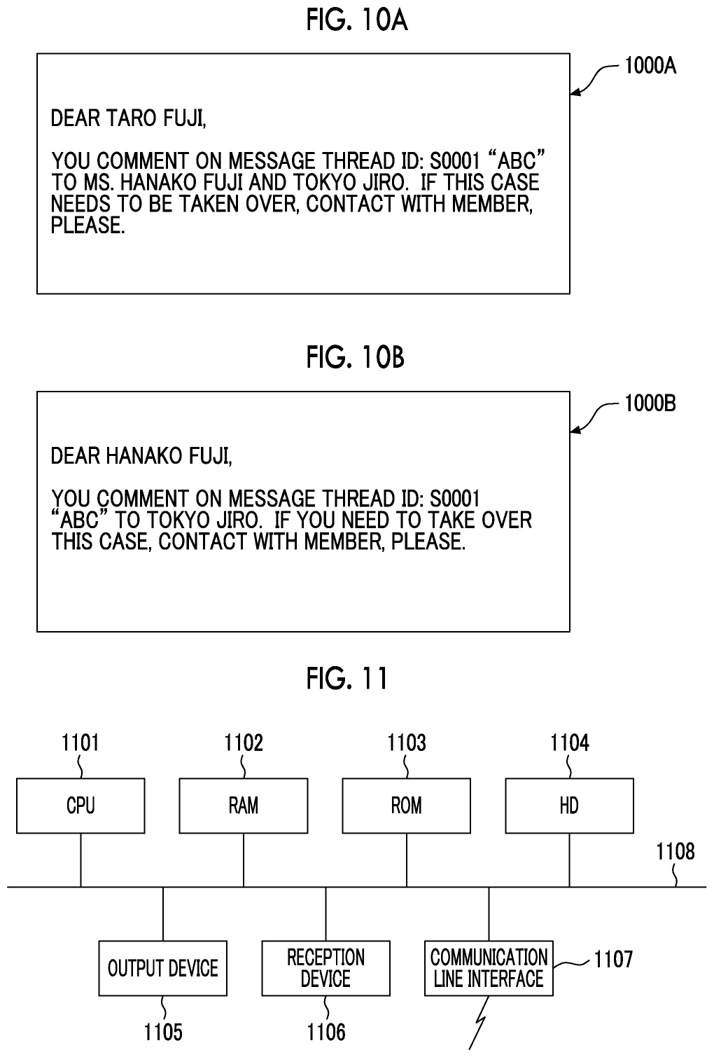

FIGS. 10A and 10B are explanatory diagrams illustrating display examples according to the present exemplary embodiment. The display examples of the user terminal for member to be withdrawn 150 and the user terminal for member 170 on which the notification is performed in step S712 are illustrated.

A message 1000A illustrated in FIG. 10A is displayed on a display device of the user terminal for member to be withdrawn 150.

For example, “Dear Taro Fuji, you comment on the message thread ID: S0001 “ABC” to Ms. Hanako Fuji and Tokyo Jiro. In a case where this case needs to be taken over, contact with the member, please.” is displayed in the message 1000A.

A message 1000B illustrated in FIG. 10B is displayed on a display device of the user terminal for member 170.

For example, “Dear Hanako Fuji, you comment on the message thread ID: S0001 “ABC” to Tokyo Jiro. If you need to take over this case, contact with the member, please.” is displayed in the message 1000B.

In addition, in a case where ToDo information is used in the community, the following process may be further performed.

First, the ToDo information includes at least the following contents. Further, the ToDo information is stored in the workspace information storage module 110.

a deadline

executed/not executed [any one]

a description of ToDo (That is, sentence in which what to do is written)

an ID of a user who executes the ToDo (in some cases, there are a plurality of users)

an ID of a user who sets the ToDo

an ID of a document or a message thread related to the ToDo (in some cases, the document or the message is not set)

an ID of a user who confirms to execute the ToDo (in some cases, the user is not set)

The involvement difference detecting module 115 searches the ToDo of which the user is a user who executes the ToDo, a user who confirms to execute the ToDo, or a user who sets the ToDo from the workspace information storage module 110 for the member to be withdrawn transferred from the access control module 105.

A difference is detected from the searched ToDo depending on the following rules.

“The user who confirms to execute the ToDo” has a higher degree of involvement than “user who executes the ToDo”.

“The user who sets the ToDo to be executed” has a higher degree of involvement than “user who executes the ToDo”.

In a case where “the user who executes the ToDo”, “the related document or message thread exists”, and “the description of the ToDo is “review”, “comment”, “approving”, or the like”, “the user who executes the ToDo” has a higher degree of involvement than “the user in the related document or message thread”.

In a case where there are a plurality of users who execute the ToDo and the related document or message thread exists, differences in the involvement of the plurality of users are detected from the related document or message.

The transition instruction module 120 generates the transition information from the differences in the involvement in the ToDo and notifies the member who involves in the ToDo of the transition information. Also, it is also possible to generate a new ToDo in which the action request is described as ToDo. In addition, in a case where the withdrawal notification is configured to include a planned withdrawal date of the member to be withdrawn, the deadline of the ToDo to be generated may be set to a date up to the planned withdrawal date.

As illustrated in FIG. 11, a hardware configuration of a computer in which a program as the present exemplary embodiment (information processing apparatus 100, user terminal for member to be withdrawn 150, and user terminal for member 170) is executed includes a general computer and specifically includes a personal computer, a computers which is a server, or the like. That is, as a specific example, a CPU 1101 is used as a processing unit (calculation unit) and a RAM 1102, a ROM 1103, and an HD 1104 are used as storage devices. For example, a hard disk or a solid state drive (SSD) may be used as the HD 1104.

The computer is configured to include the CPU 1101 which executes programs such as the access control module 105, the involvement difference detecting module 115, the transition instruction module 120, the member withdrawal notification module 155, the workspace access module 160, the transition information confirming module 165, the workspace access module 175, the transition information confirming module 180, and the like, the RAM 1102 which stores the programs or data, the ROM 1103 which stores a program or the like for activating the computer, the HD 1104 which is an auxiliary storage device having a function as the workspace information storage module 110 or the like (may be a flash memory or the like), a reception device 1106 which receives data based on an operation of the user (including operation, voice, line of sight, or the like) on a keyboard, a mouse, a touch screen, a microphone, a camera (including a sight line detection camera and the like), an output device 1105 such as a CRT, a liquid crystal display, a speaker, or the like, a communication line interface 1107 for connecting with a communication network such as a network interface card or the like, and a bus 1108 for connecting with the devices and exchanging the data therebetween. A plurality of computers may be connected to each other via the network.

Among the exemplary embodiments described above, in a case of a computer program, the computer program which is software is read into a system of the hardware configuration, and the software and hardware resources cooperate with each other, and the exemplary embodiment described above is realized.

The hardware configuration illustrated in FIG. 11 illustrates one configuration example, but the present exemplary embodiment is not limited to the configuration illustrated in FIG. 11. As long as a configuration can execute the modules described in the present exemplary embodiment, the configuration may be included in the hardware configuration. For example, some of the modules may be configured with dedicated hardware (for example, application specific integrated circuit (ASIC) or the like) or some of the modules may be connected to a communication line in an external system. Further, a plurality of systems illustrated in FIG. 11 may be connected to one another via a communication line so as to cooperate with one another.

In particular, in addition to a personal computer, it is also possible to use a mobile information communication device, an information appliance, a robot, a copying machine, a facsimile, a scanner, a printer, a multifunction device (image processing apparatus having at least two functions of a scanner, a printer, a copying machine, a facsimile, or the like) and the like.

The described program may be stored in a recording medium and provided or the program may be provided by communication means. In this case, for example, the program described above may be regarded as “a computer-readable recording medium recording a program”.

“A computer-readable recording medium recording a program” means a computer-readable recording medium on which a program is recorded, which is used for installing and executing programs, distributing programs and the like.

The recording medium includes, for example, a digital versatile disc (DVD) and includes “DVD-R, DVD-RW, DVD-RAM, and the like” which are standards established by DVD forum and “DVD+R, DVD+RW, and the like” which are standards established by DVD+RW as a digital versatile disc (DVD) and a read-only memory (CD-ROM), a CD recordable (CD-R), a CD rewritable (CD-RW), a Blu-ray (registered trademark) disc, a magneto-optical disc (MO), a flexible disc (FD), a magnetic tape, a hard disc, a read only memory (ROM), an electrically erasable and rewritable read-only memory (EEPROM (registered trademark)), a flash memory, a random access memory (RAM), a secure digital (SD) memory card, and the like as a compact disc (CD).

Then, all or some of the programs may be stored, distributed, or the like by being recorded on the recording medium. Further, the communication may be transmitted, for example, by using a wired network or a wireless communication network used for a local area network (LAN), a metropolitan area network (MAN), a wide area network (WAN), the internet, an intranet, an extranet, and the like or a transmission medium such as a combination thereof and may be transmitted by using a carrier wave.

The program may be a part or all of another program or may be recorded on the recording medium together with a separate program. Further, the program may be divided and recorded on a plurality of recording media. In addition, the program may be recorded in any form as long as the program can be restored, such as compression or encryption.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a detecting section that detects a difference in degrees of involvement in communication in a community in which a plurality of users participate or a product in the community, between users in the community; and
a notification section that notifies, in a case where a predetermined event occurs in the future, based on the difference detected by the detecting section, a first user related to the event or a second user having the difference from the first user of an action request.

2. The information processing apparatus according to claim 1,
wherein the event is withdrawal or long-term absence from the community, and
the first user is a withdrawer or a long-term absentee.

3. The information processing apparatus according to claim 2,
wherein the second user is a user having a lower degree of involvement than the first user.

4. The information processing apparatus according to claim 2,
wherein the notification section does not perform a notification on a user having a high degree of involvement than the first user.

5. The information processing apparatus according to claim 1,
wherein the notification section selects a user who communicates with the first user or a user who involves in the product together with the first user, as the second user.

6. The information processing apparatus according to claim 5,
wherein the notification section further includes a condition that the user is a user who performs a predetermined operation on the first user, as the second user.

7. A non-transitory computer readable medium storing an information processing program causing a computer to function as:
a detecting section that detects a difference in degrees of involvement in communication in a community in which a plurality of users participate or a product in the community, between users in the community; and
a notification section that notifies, in a case where a predetermined event occurs in the future, based on the difference detected by the detecting section, a first user related to the event or a second user having the difference from the first user of an action request.

8. An information processing apparatus comprising:
detecting means for detecting a difference in degrees of involvement in communication in a community in which a plurality of users participate or a product in the community, between users in the community; and
notification means for notifying, in a case where a predetermined event occurs in the future, based on the difference detected by the detecting section, a first user related to the event or a second user having the difference from the first user of an action request.
